(19) United States
(12) Patent Application Publication
(10) Pub. No.: US 2016/0235252 A1
(43) Pub. Date: Aug. 18, 2016

(54) BLENDER DISK

(71) Applicant: Sagan LLC, San Diego, CA (US)

(72) Inventors: Richard B. Muir, San Diego, CA (US); Dennis Clements, Cedar City, UT (US); David J. Corey, San Diego, CA (US)

(21) Appl. No.: 15/045,013

(22) Filed: Feb. 16, 2016

Related U.S. Application Data
(60) Provisional application No. 62/117,328, filed on Feb. 17, 2015.

(51) Int. Cl. A47J 43/27

(52) U.S. Cl. CPC A47J 43/27

(57) ABSTRACT

A blender disk for use in a fluid container is disclosed. A blender disk includes a pattern of ribs, cross members and voids which can interrupt or impede flow through the blender disk. The interruption or impediment to flow can result in mixing of a substance and a fluid within the fluid container. The blender disk can be moveably attached to a straw extending into the fluid container.

### CROSS REFERENCE TO RELATED APPLICATIONS

This application claims the benefit of priority to provisional U.S. application No. 62/117,328, filed Feb. 17, 2015, the entire contents of which are herein incorporated by reference.

### BACKGROUND

1. Field of the Invention

This application relates to the blending of beverages in a fluid container, such as in a water bottle. This application pertains to a novel blender disk that attaches to a straw in the fluid container. The present invention can be utilized to easily and thoroughly mix powdered drink mixes and liquids in a fluid container.

2. Description of the Related Art

A fluid container can be used to hold a fluid, such as water, and frequently one may desire to add an additional material, such as a powdered or liquid flavoring, dietary supplements, protein powders, additional ingredients, or other substances to the fluid. Within a fluid container, it may be difficult to ensure adequate mixing of the added substance. Several fluid containers now comprise of straws that allow for sipping rather than chugging from an opening in the lid.

### SUMMARY

Some aspects described herein include a fluid container comprising a shell for containing a fluid; a straw extending into the container; a blender disk removably connected to the straw; wherein the blender disk comprises a pattern of ribs, cross members, and voids configured to create turbulent flow passing through the blender disk within the shell. Preferably, the blender disk affixes to the straw by a friction fit. This allows the disk to be removed easily by hand and without the need of tools.

When mixing powdered drink mixes in a fluid container, one may have to shake it in order for the solution to thoroughly mix. This can be aggravating, especially when some powdered drink mixes do not easily dissolve, like a protein powder mix. This can result in chunky and non-homogeneous drinking experiences. The non-homogeneous solution can cause plugging of the straw rendering the user unable to drink the liquids in the fluid container. Blender disks as described herein can be advantageous, in part, by providing a more homogenous mixing and a better drinking experience for users.

In one aspect, a fluid container comprises a shell for containing a fluid; a straw extending into the container; and a blender disk removably connected to the straw, wherein the blender disk comprises a pattern of ribs, cross members, and voids configured to create turbulent flow passing through the blender disk within the shell

In some embodiments, the removable lid has an outlet therein. In some embodiments, the fluid container comprises a plurality of blender disks connected to the straw.

In some embodiments, the fluid container comprises a ring attached to one end of the straw, wherein the ring prevents the removal of the blender disk.

In some embodiments, the fluid container comprises a sheath attached to one end of the blender disk, wherein the sheath encompasses the straw extending into the container, wherein the sheath is affixed to the removable lid.

In some embodiments, the blender disk is affixes to the straw by a screw, wherein the screw is threaded through the blender disk to form a pressed fit with the straw. In some embodiments, the blender disk is integrally formed with the straw.

In another aspect, a fluid container comprises a shell for containing a fluid; a removable lid connected to the container; and a blender disk affixed to the container, wherein the blender disk comprises a pattern of ribs, cross members, and voids configured to create turbulent flow passing through the blender disk within the shell.

In some embodiments, the fluid container comprises a suspension post, wherein the blender disk is affixed to the suspension post.

In some embodiments, the fluid container comprises a blender disk with a snap lock mechanism, wherein the snap lock mechanism is readily manually snapped into operative position and which positively locks in place the blender disk in the fluid container.

In some embodiments, the blender disk is attached to the suspension post by a snap lock mechanism, wherein the snap lock mechanism components in combination secures the blender disk and the suspension post to the fluid container.

In some embodiments, blender disk is affixed to the base of the container by a suspension post.

In some embodiments, the blender disk is attached to the suspension post by a snap lock mechanism, wherein the snap lock mechanism components in combination secures the blender disk and the suspension post.

In some embodiments, the blender disk is affixed to the shell by a snap lock mechanism, wherein the snap lock mechanism components in combination secures the blender disk and the shell of the fluid container.

In another aspect, a method of using a fluid container comprises providing a fluid container comprising: a shell for containing a fluid; a lid removably attachable to the shell; and a straw connected to the lid; attaching a blender disk to the straw, the blender disk comprising a pattern of ribs, cross members, and voids configured to create turbulent flow passing through the blender disk within the shell; attaching the lid to the shell to extend the straw into the shell; disposing a fluid within the shell; and agitating the fluid container to cause a fluid disposed within the container to flow through the voids in the blender disk.

In some embodiments, the method further comprises disposing a dry additive in the fluid container to dissolve within the fluid.

In some embodiments, the method comprises dissolving the dry additive within the fluid by agitating the fluid container.

In some embodiments, agitating the fluid container comprises generating turbulent flow through and around the blender disk within the shell.

These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings.

FIG. 1A depicts a side view of an embodiment fluid container having a straw with a blender disk removably connected thereto. In this and subsequent figures, the fluid container is depicted as having transparent sides for ease of illustration.

FIG. 1B depicts a side view of a straw with a blender disk removably connected thereto.

FIG. 2A depicts a top view of an embodiment of a blender disk.

FIG. 2B depicts a perspective view of an embodiment of a blender disk.

FIG. 3A depicts a side view of an embodiment of a water bottle having a blender disk suspended by the walls of the container.

FIG. 3B depicts a side view of an embodiment of a water bottle having a blender disk suspended by a protruding edge within the container.

FIG. 3C depicts an embodiment of a fluid container with a blender disk suspended by a snap fit to the shell of the container.

FIG. 4A depicts a side view of an embodiment of a water bottle having a blender disk affixed to the bottom of the container.

FIG. 4B depicts a side view of an embodiment of a water bottle having a blender disk affixed to the lid of the container.

FIG. 5 depicts a side view of an embodiment of a water bottle having a straw with a blender disk.

FIG. 6 depicts a side view of an embodiment of a water bottle having a straw with a blender disk sheath removably connected thereto.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein and as illustrated in the figures, can be arranged, substituted, combined and designed in a wide variety of configurations, all of which are explicitly contemplated and made part of this disclosure.

As used herein, the term turbulent flow may refer to an interrupted or diverted fluid flow around an obstacle which results in formation of localized eddies and currents.

Some embodiments disclosed herein relate generally to a blender disk. Specifically, some embodiments relate to a blender disk for use in a fluid container, such as a water bottle. The blender disk can have an internal structure within an outer frame in order to interrupt, divert, redirect, or alter the flow of water through the blender disk, thereby creating a turbulent flow in a water bottle to blend a substance in a fluid within the water bottle.

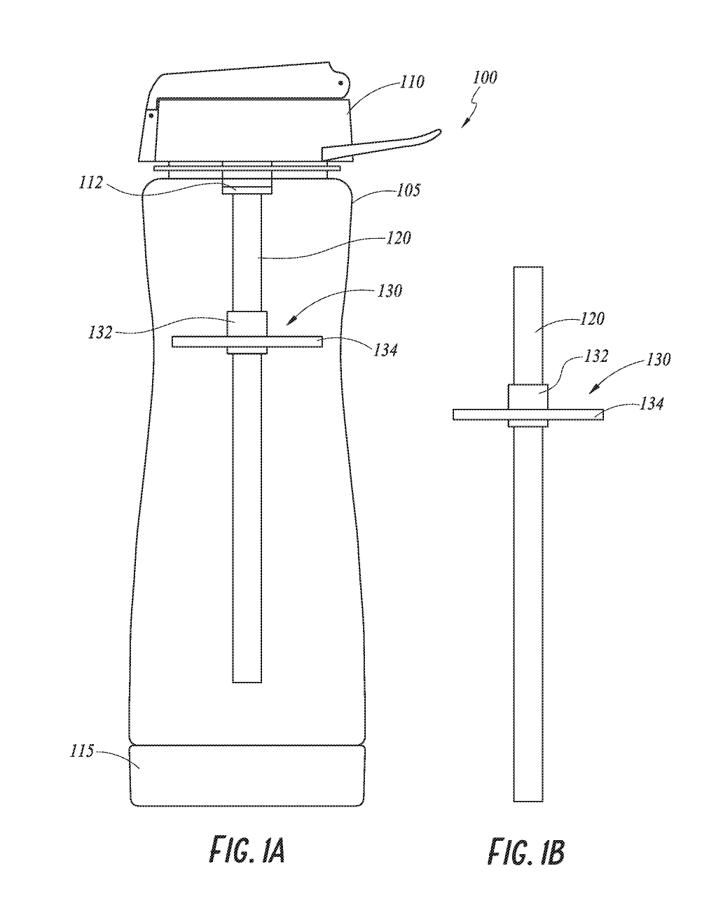

FIG. 1A depicts an embodiment of a fluid container with a blender disk disposed therein. A container 100 comprises a shell 105, a lid 110, and a base 115. The shell 105 can be a hard or soft, impervious material for holding a fluid. The lid 110 can be removably attached to the shell 105 via threads, a friction fit and a gasket, or any other connection method known in the art. The shell 105 and lid 110 can be made from various plastics, metals, durable glass materials, or any non-toxic material suitable for containing and agitating powders and liquids. The lid 110 can include an outlet (not shown) built in to the lid, or an outlet may be accessible when the lid is removed. The lid 110 can be removable to allow access to the shell 105 to add a fluid, such as water, and another substance, such as a supplement, flavoring, a powder, a second fluid, or any other desired substance. In some embodiments, the lid 110 comprises a connector 112 in fluid communication with a straw 120. The straw 120 extends into the container 100. The straw 120 can be a hollow, cylindrical tube which extends to or near to the base 115 of container 100. A fluid (not shown) can be retained within the shell 105 such that the straw 120 is at least partially submerged or immersed in the fluid.

A blender disk 130 can be removably connected to the straw 130. The blender disk 130 can be made of silicon, rubber, plastic, metal or any non-toxic material suitable for agitating powders and liquids. In some embodiments, the blender disk 130 comprises a sleeve 132 and a rim 134. The sleeve 132 is sized and shaped to surround the straw 120 and to provide a friction fit to the straw 120, as will be described below. In some embodiments, the sleeve 132 can be integrally formed with the straw 120. The sleeve 132 supports one or more ribs (not shown) which extend outward from the sleeve 132 and which connect to the rim 134. The rim 134 may be circular, oval, square, triangular, or any other desired shape. In some embodiments, the rim may have a diameter or circumference or other dimension such that the blender disk can be removed from an opening in the shell 105. In some embodiments, the rim 134 may be sized and/or shaped such that the blender disk is larger than, or has at least one dimension larger than, the opening in the shell 105 onto which the lid 110 is attached.

In some embodiments, the blender disk 130 is positioned at a midpoint of the straw 120. In some embodiments, the blender disk 130 is positioned on the straw 120 as to be proximate one end or the other. The position of the blender disk 130 can be changed by applying a force to the blender disk 130 sufficient to overcome a frictional force between the inner surface of the sleeve 132 and an outer surface of the straw 120. In some embodiments, the blender disk 130 can be fixedly attached to the straw 120 at any desired position.

The blender disk 130 can be advantageously moved to any location on the straw 120 desired by the user for mixing a substance into the fluid within the container 100. Because the blender disk 130 is removably attached to the straw 120, as a fluid is agitated, the blender disk stays in place as the fluid flows around and through the blender disk 130, which results in more efficient mixing of a fluid than if the blender disk 130 was loose or unattached within the container 100.

A circular blender disk 130 having radially extending ribs 136 and concentric cross members has been described herein. The blender disk 130 of the current disclosure can be oval, square, triangular, or any other desired shape, with a pattern of ribs and cross members suited to the shape of the blender disk, without departing from the scope of the present application.

In some embodiments, the straw 120 can be a stem, tube, channel, conduit, pipe or any other device that is known in the art that can transfer a liquid from within the shell 105 to the lid 110.

In some embodiments, the lower end of the straw 120 does not approach the base 115 of the container 100. In some embodiments, the sleeve 132 includes a pliable or semi-pliable internal protrusion (not shown) which allows the blender disk 130 to attach to any straw 120 that may be too small to provide a friction fit. The internal protrusion can be inserted into the sleeve 132, and the straw 120 can then be inserted to form a friction fit connection.

In some embodiments, multiple blender disks 130 can be disposed on a straw 120 to advantageously improve agitation and mixing.

FIG. 1B depicts the straw 120 removed from the shell 105 of the container 100. The straw 120 can be formed of a rigid, semi-rigid, or flexible material.

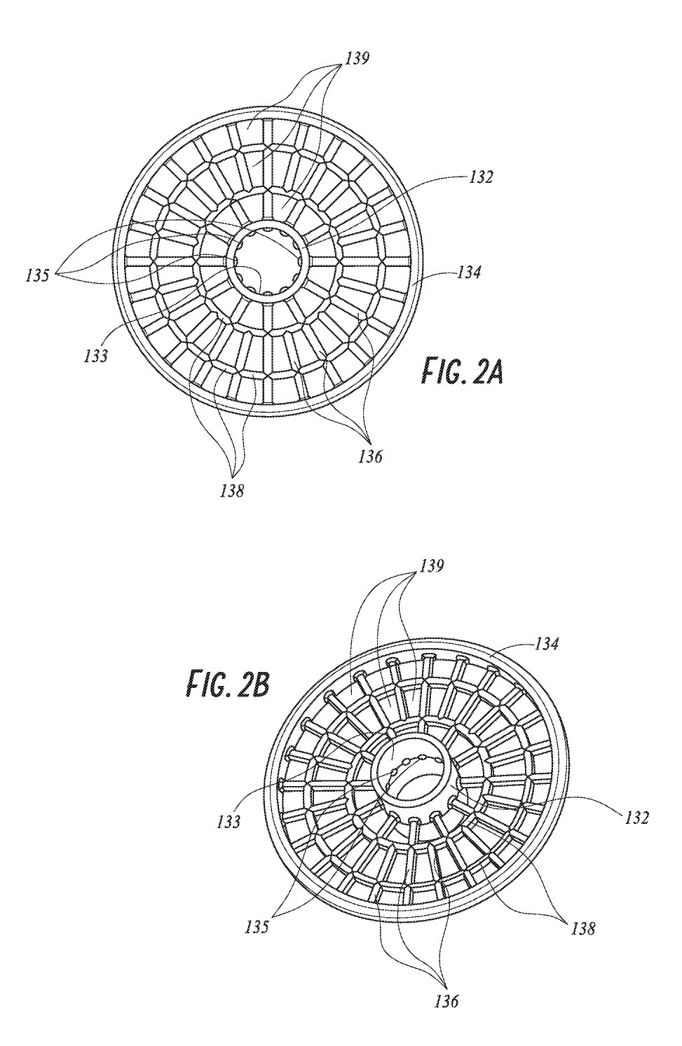

FIG. 2A depicts a top view of the blender disk 130. The blender disk comprises the sleeve 132 and the rim 134 as described above. Also as described above, one or more ribs 136 extend between the sleeve 132 and the rim 134 to attach the rim 134 to the sleeve, and to provide a blending structure, as will be described below. One or more cross members 138 extend between the ribs 136. The cross members 138 can connect to adjacent ribs 136 to provide a support structure for the ribs 136, and to provide a blending structure. In some embodiments, the one or more cross members 138 extend circumferentially and concentrically around the sleeve 132. In some embodiments, one or more ribs 136 can extend from the sleeve 132 to the rim 134. In some embodiments, one or more ribs 136 can extend from the rim 134 to one of the concentric cross members 138, or from the sleeve 132 to one or more of the concentric cross members 138.

One or more blending voids 139 are formed by the pattern of ribs 136 and cross members 138. The one or more blending voids 139 can be of the same size and shape, or can be of varying sizes and shapes depending on the location of the void 139 within the pattern of ribs 136 and cross members 138.

The sleeve 132 is formed with one or more protrusions 135 extending from an inner surface 133 of the sleeve into a channel configured to receive the straw 120. The protrusions 135 can extend so as to create a friction fit between the protrusions 135 and the straw 120. The protrusions 135 movably secure the blender disk 130 to the sleeve, and also allow for the blender disk 130 to be slidably moved along the straw 120 by the application of a force greater than the frictional force. The protrusions 135 are sized and shaped so as to create a frictional fit which will keep the blender disk 130 in position on the straw 120 when a fluid is passed over or through the blender disk 130, but which can be easily moved by a user's hand.

FIG. 2B depicts a perspective view of the blender disk 130 of FIG. 2A. To use the blender disk 130, a user may add a fluid, such as water, to the shell 105. The user may desire to add another substance, such as a powder or liquid flavor, a protein powder, a supplement, or other substance which can be advantageously mixed with the fluid in the container 100. To mix the fluid and the added substance, a user agitates the container 100. As the container 100 is agitated, the fluid and the added substance moves within the shell 105. As the fluid impacts the blender disk 130, the ribs 136 and the cross members 138 impede the flow path of the fluid. The fluid is forced through the voids 139 in the pattern of ribs 136 and cross members 138, and a turbulent or agitated flow in the fluid is created. In the turbulent or agitated flow pattern, a substance added to the fluid can be advantageously mixed by the localized turbulent flow patterns around and throughout the blender disk 130, which works to dissolve and/or disperse the substance into the bottle. The result of the agitation can be used to create a homogeneous mixture of the contents of the bottle.

Although a round or circular blending disk is described herein, a person of skill in the art would understand that a blending disk can have other shapes, without departing from the scope of the present disclosure. For example, the blending disk can be generally oval, triangular, square, rectangular, diamond, or any other desired shape. In some embodiments, the blending disk shape can be selected to match a shape of an internal cross section of a fluid container.

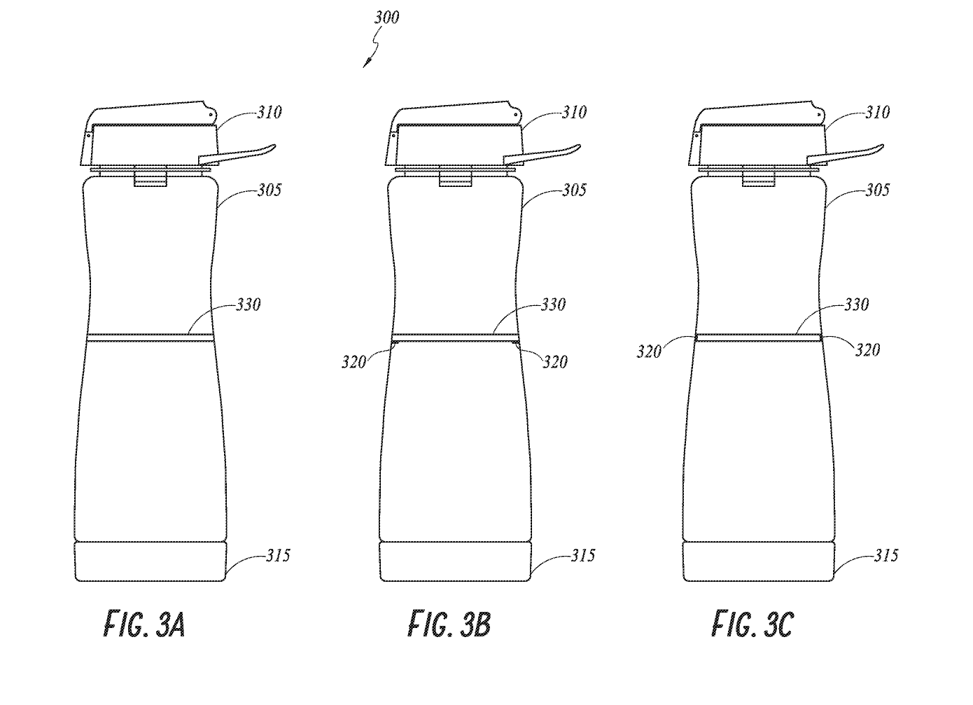

FIG. 3A depicts an embodiment of a fluid container with a blender disk disposed therein. A container 300 comprises a shell 305, a lid 310, and a base 315. The shell 305 can be a hard or soft, impervious material for holding a fluid. The lid 310 can be removably attached to the shell 305 via threads, a friction fit and a gasket, or any other desired connection method. The shell 305 and lid 310 can be made from various plastics, metals, durable glass materials, or any non-toxic material suitable for containing powders and liquids. The lid 310 can include an outlet (not shown) built in to the lid, or an outlet may be accessible when the lid is removed. As shown, the blender disk 330 is suspended by the walls of the shell 305 when the periphery of the blender disk 330 contacts an inner surface of the shell 305 forming a friction fit. The position of the blender disk 330 is approximately half the distance between the lid 310 and the base 315 in the container 300. The blender disk 330 can be moved along the shell 305 of the container 300 with an application of a force greater than the frictional force.

In some embodiments, the blender disk can be positioned in a narrow portion of the fluid container, and have a size configured to friction fit into the narrowest portion of the fluid container. In some embodiments, the blender disk can be removably attached to the inner shell, such as via a snap fit, or can be non-removably attached to the inner surface of the shell 305, such as being glued in or integrally formed with the shell 305.

The blender disk 330 can be positioned, in the upper quarter or lower quarter of the shell 305. In some embodiments, one or more blender disks 330 can be suspended by the shell 305 to improve agitation and mixing.

In some embodiments, the blender disk 330 can be integrally formed within the shell. The integral formation is a permanent connection so as to make up a single completed piece of the shell 305 and the blender disk 330. The connection becomes part of, or is interconnected with, the shell 305 and blender disk 330.

In some embodiments, the blender disk 330 is attached to the shell 305 by an adhesive. An adhesive can be any glue, hot melt, solvent rubber, acrylic, silicones, epoxy, phenolic, wax, polyurethane, or any material that is known in the art to act as an adhesive.

FIG. 3B depicts a side view of an embodiment of a fluid container having a blender disk suspended by a protruding edge within the container. The blender disk 330 is attached to the shell 305 by a protruding edge 320 from the interior of the shell 305. In some embodiments, the blender disk 330 snap locks into place. The protruding edge 320 of the shell 305 has a snap lock mechanism attached to the protruding edge 320 and the blender disk 330 has a snap fit for locking the blender disk 330 into place. The snap lock mechanism between the protruding edge 320 from the interior of the shell 305 and the blender disk 330 can be readily manually snapped into operative position and which positively locks in place, and yet at the same time can be readily separated when desired.

The snap lock mechanism can be engaged and released without the use of tools. Thus, the snap lock mechanism may be released in the fluid container 300 by the user by hand and does not damage or deform the lock structure. In some embodiments, a plurality of snap fits can be used to secure the blender disk 330 to the protruding edge 320. The snap locking between the protruding edge 320 from the interior of the shell 305 and the blender disk 330 can be readily manually snapped into operative position and which positively locks in place, and yet which at the same time can be readily separated when desired.

In some embodiments, the protruding edge and blender disk are integrally formed similar to the integrally formed blender disk and shell, as described above.

FIG. 3C depicts an embodiment of a fluid container with a blender disk suspended by a friction fit to the shell 305. The blender disk 330 can be connected to the shell 305 similar to the connection with the protruding edge 320, as described above.

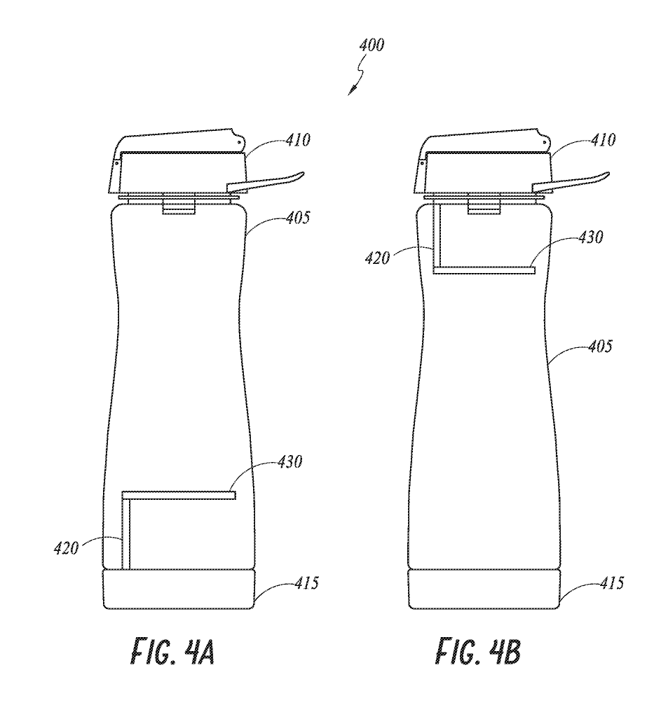

FIG. 4A depicts an embodiment of a fluid container with a blender disk disposed therein. A container 400 comprises a shell 405, a lid 410, and a base 415. The components of the container 400 can be similar to those described elsewhere herein. The lid 410 can include an outlet (not shown) built in to the lid, or an outlet may be accessible when the lid is removed. The blender disk 430 is affixed to the base 415 by a suspension post 420. The suspension post 420 can extend perpendicularly or at another angel from the surface of the base 415 into the internal cavity of the shell 405. The suspension post 420 can be removably or fixedly attached to the base 415. The suspension post 420 connects to the blender disk via a fixed or removable connection, such that the blender disk 430 is disposed generally parallel to the base 415. The suspension post 420 is connected to the blender disk 430 to hold in place the blender disk 430 during agitation of fluid within the container 400. The suspension post 420 can be made of silicon, rubber, plastic, metal or any non-toxic material suitable for agitating powders and liquids. The suspension post 420 can be connected to any part of the base 415. In some embodiments, the suspension post 420 is integrally formed with the blender disk 430 and the container 400.

In some embodiments, the suspension post 420 can be attached to the shell 405 in addition to, or rather than to the base 415. In some embodiments, the suspension post 420 is attached to the container 400 by an adhesive. An adhesive can be any glue, hot melt, solvent rubber, acrylic, silicones, epoxy, phenolic, wax, polyurethane, or any material that is known in the art to act as an adhesive.

In some embodiments, the suspension post 420 is attached to the container 400 by a protruding edge from the base 415 of the container 400 wherein the suspension post 420 snap locks into place. In some embodiments, the snap locking between the protruding edge from the base 415 and the suspension post 420 can be readily manually snapped into operative position and which positively locks in place, and can also be readily separated by applying a manual force when desired. The suspension post 420 and the protruding edge of the base 415 may be snapped into place in any relative axial position thereby presenting no alignment problems when assembling the present invention. The suspension post 420 can be connected to the blender disk 430 similar to the connection with the shell 405, described above.

The blender disk 430 is integrally formed with the suspension post 420. In some embodiments, the blender disk 430 attaches to the suspension post 420 by snap click. In some embodiments, the blender disk 430 attaches to the suspension post 420 by an adhesive. In some embodiments, a plurality of suspension posts 420 can be used to support the blender disk 430.

FIG. 4B depicts an embodiment of a fluid container with a blender disk disposed therein. The blender disk 430 is affixed to the lid 410 by a suspension post 410. The suspension post 410 firmly holds in place the blender disk 430. The suspension post 420 can be made of silicon, rubber, plastic, metal or any non-toxic material suitable for agitating powders and liquids. The suspension post 420 can be connected to the lid similar to the connection with the base 415, described above.

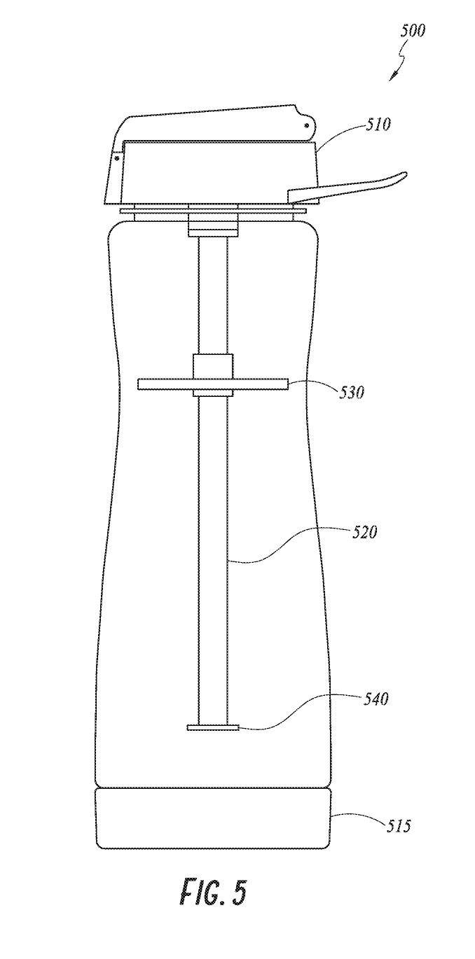

FIG. 5 depicts an embodiment of a fluid container with a blender disk disposed therein. A container 500 comprises a shell 505, a lid 510, a base 515, and a straw 520. The components of the container 500 can be similar to those described elsewhere herein. The straw 520 extends into the container 500 toward the base 515. The blender disk 530 is loose fitting on the straw 520 and the blender disk 530 moves freely up and down the straw 520. The blender disk 530 can be moved up and down the straw 520 by simple shaking, rotation, circular motions or other oscillations or random movement. The movement of the blender disk 530 up and down the straw generates additional inertia that works to lessen the effort needed to fully mix the contents of the container 500. The blender disk 530 is prevented from falling off the straw 520 by the ring 540. The ring 540 is sized and shaped to surround the straw 540 and to provide a friction fit to the straw 540, and sized to have an outer diameter larger than the inner diameter of a sleeve on the blender disk 530, to prevent the blender disk 530 from coming off the end of the straw 520 as the blender disk 530 moves along the straw 520. The ring 540 can be made of silicon, rubber, plastic, metal or any non-toxic material suitable for agitating powders and liquids. The ring 540 can be a flat disk shaped, parabolic, ellipsoidal, flattened parabolic, or any desired shape.

In some embodiments, the ring 540 is integrally formed with the straw 520. In some embodiments, the blender disk 530 can form a tight fit with which prevents free movement on the straw 520. As force is applied by shaking of the container 500, the blender disk 530 moves up and down the straw 520 causing the agitation as described above.

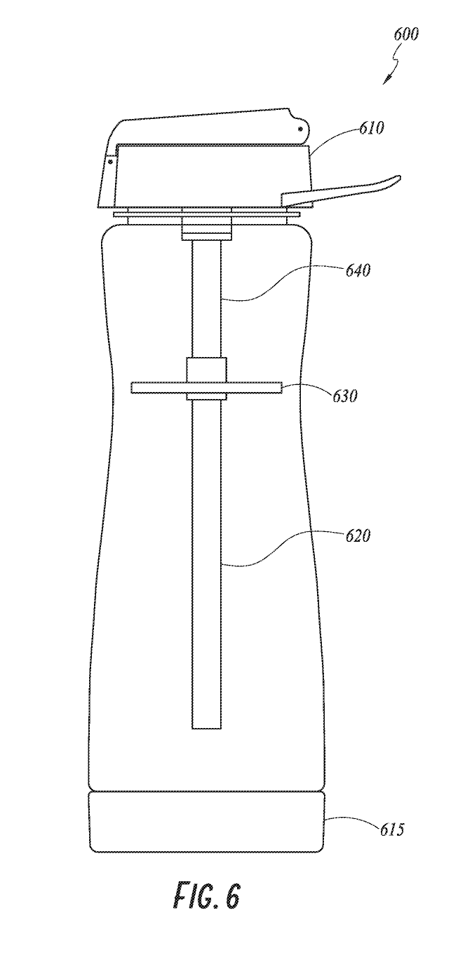

FIG. 6 depicts an embodiment of a fluid container having a straw with a blender disk sheath removably connected thereto. A container 600 comprises a shell 605, a lid 610, and a base 615. The shell 605 can be a hard or soft, impervious material for holding a fluid. The lid 610 can be removably attached to the shell 605 via threads, a friction fit and a gasket, or any other connection method known in the art. The shell 605 and lid 610 can be made from various plastics, metals, durable glass materials, or any non-toxic material suitable for containing and agitating powders and liquids. The lid 610 can include an outlet (not shown) built in to the lid, or an outlet may be accessible when the lid is removed. The container 600 also includes a sheath 640. The sheath is attached to either the lid 610, or the straw 620 or both. The sheath 640 comprises a substantially circular tube having a distal end and a proximal end. The straw 620 is inserted into the sheath 640 and can be disposed within the sheath 640 when the lid 610 is attached. In some embodiments, the straw 620 can be withdrawn, leaving the sheath 640 in place. The sheath 640 can be made from various plastics, metals, durable glass materials, or any non-toxic material suitable for containing and agitating powders and liquids.

A blender disk 630 is connected to an end of the sheath 640 opposite the end connected to the lid 610. The blender disk 630 can be similar to those described elsewhere herein. The blender disk 630 can be fixedly or removably attached to the end of the sheath 640.

To use the blender disk 130, a user may add a fluid, such as water, to the shell 105. The user may desire to add another substance, such as a powder or liquid flavor, a protein powder, a supplement, or other substance which can be advantageously mixed with the fluid in the container 100. To mix the fluid and the added substance, a user agitates the container 100. As the container 100 is agitated, the fluid and the added substance moves within the shell 105. As the fluid impacts the blender disk 130, the ribs 136 and the cross members 138 impede the flow path of the fluid. The fluid is forced through the voids 139 in the pattern of ribs 136 and cross members 138, and a turbulent or agitated flow in the fluid is created. In the turbulent or agitated flow pattern, a substance added to the fluid can be advantageously mixed by the localized turbulent flow patterns around and throughout the blender disk 130, which works to dissolve and/or disperse the substance into the bottle. The result of the agitation can be used to create a homogeneous mixture of the contents of the bottle.

In this section, certain specific details of the disclosed embodiments are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this disclosure be limited to the specific embodiments disclosed herein, but that it cover all modifications and alternatives coming within the true scope and spirit of the disclosure as embodied in the attached claims.

What is claimed is:

1. A fluid container comprising:
a shell for containing a fluid;
a straw extending into the container; and
a blender disk removably connected to the straw, wherein the blender disk comprises a pattern of ribs, cross members, and voids configured to create turbulent flow passing through the blender disk within the shell.

2. The fluid container of claim 1, further comprising a removable lid having an outlet therein.

3. The fluid container of claim 1, further comprising a plurality of blender disks connected to the straw.

4. The fluid container of claim 1, further comprising a ring attached to one end of the straw, wherein the ring prevents the removal of the blender disk.

5. The fluid container of claim 1, further comprising a sheath attached to one end of the blender disk, wherein the sheath encompasses the straw extending into the container, wherein the sheath is affixed to the removable lid.

6. The fluid container of claim 1, wherein the blender disk is affixes to the straw by a screw, wherein the screw is threaded through the blender disk to form a pressed fit with the straw.

7. The fluid container of claim 1, wherein the blender disk is integrally formed with the straw.

8. A fluid container comprising:
a shell for containing a fluid;
a removable lid connected to the shell; and
a blender disk affixed to the shell, wherein the blender disk comprises a pattern of ribs, cross members, and voids configured to create turbulent flow passing through the blender disk within the shell.

9. The fluid container of claim 8, further comprising a removable lid having an outlet therein.

10. The fluid container of claim 8, further comprising a suspension post, wherein the blender disk is affixed to the suspension post.

11. The fluid container of claim 8, further comprising a blender disk with a snap lock mechanism, wherein the snap lock mechanism is readily manually snapped into operative position and which positively locks in place the blender disk in the fluid container.

12. The fluid container of claim 8, wherein the blender disk is integrally formed with the shell of the fluid container.

13. The fluid container of claim 8, wherein the blender disk is attached to the suspension post by a snap lock mechanism, wherein the snap lock mechanism components in combination secures the blender disk and the suspension post to the fluid container.

14. The fluid container of claim 8, wherein the blender disk is affixed to the base of the container by a suspension post.

15. The fluid container of claim 8, wherein the blender disk is attached to the suspension post by a snap lock mechanism, wherein the snap lock mechanism components in combination secures the blender disk and the suspension post.

16. The fluid container of claim 8, further comprising a sheath attached to one end of the blender disk, wherein the sheath is affixed to the removable lid, wherein the sheath extends into the shell.

17. A method of using a fluid container comprising:
providing a fluid container comprising:
a shell for containing a fluid;
a lid removably attachable to the shell; and
a straw connected to the lid;
attaching a blender disk to the straw, the blender disk comprising a pattern of ribs, cross members, and voids configured to create turbulent flow passing through the blender disk within the shell;
attaching the lid to the shell to extend the straw into the shell;
disposing a fluid within the shell; and
agitating the fluid container to cause a fluid disposed within the container to flow through the voids in the blender disk.

18. The method of claim 17, further comprising disposing a dry additive in the fluid container to dissolve within the fluid.

19. The method of claim 18, further comprising dissolving the dry additive within the fluid by agitating the fluid container.

20. The method of claim 17, wherein agitating the fluid container comprises generating turbulent flow through and around the blender disk within the shell.
